(19) United States
(12) Patent Application Publication
(10) Pub. No.: US 2009/0235190 A1
(43) Pub. Date: Sep. 17, 2009

(54) Managing Student Transcripts

(75) Inventors: Nelson Hoo, Vancouver (CA); Vera Walker, Tempe, AZ (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/253,417

(22) Filed: Oct. 17, 2008

Related U.S. Application Data
(60) Provisional application No. 61/036,139, filed on Mar. 13, 2008.

(51) Int. Cl. G06F 3/048

(52) U.S. Cl. 715/763

(57) ABSTRACT

Systems and software for managing student transcripts are disclosed herein. In one embodiment of a transcript management system, among several, the system comprises a network interface, which is configured in communication with a network that is associated with a university. The system further comprises a processing device configured to execute a transcript handling program. More specifically, executing the transcript handling program includes collecting data corresponding to information of one or more students associated with the university. Particularly, the data is collected from various locations on the network via the network interface. Executing the transcript handling program further includes storing the data as multiple fields in multiple results tables and allowing an administrator of the university to customize how the multiple results tables are placed on a transcript.

### CROSS-REFERENCE TO RELATED APPLICATIONS

This application claims the benefit of U.S. Provisional Application No. 61/036,139, filed on Mar. 13, 2008.

### TECHNICAL FIELD

The embodiments of the present disclosure generally relate to student transcripts. More particularly, the embodiments herein relate to the management of student transcripts with respect to transcript design, data entry, and access.

### BACKGROUND

A transcript is an official record of a student's academic history at a university or institution of higher education. Throughout a student's academic career, the student can request a copy of his or her transcript to be used to apply for further education or for a transfer to another university. After graduation, the graduate can request a copy of his or her transcript to be used to obtain professional certifications, career advancement, etc.

A significant part of the workload of the registrar's office is to manage transcripts and particularly supplying transcripts to the students or graduates making such requests. Normally, the transcripts can be printed on paper or supplied electronically. Many universities wish to create unique transcripts to distinguish them from those of other universities. To the people associated with a university, the transcript can be source of great pride. In order to simplify the management and creation of transcripts, software programs have been established to assist university administrators to design and create how the transcripts are to appear and how data is presented.

Data is gathered from various locations associated with a university, such as from admissions databases, financial aide databases, student records databases, etc. Normally, all of the pooled information from the entire system is accumulated and stored in one central location. With this information, the transcript program can manage the information to organize it according to the particular format that the university administrators desire.

Some existing transcript management software programs utilize common business-oriented language (“COBOL”) instructions to gather information from various sources and organize the data. From the various information gathered, the programs are able to produce a single results table, which is used to display or print the transcripts. For example, conventional transcript software is configured to process data in a COBOL program and sort the data into different types of fields of a results table. The results table can be presented either on-line or can be incorporated into a report writing application, e.g., Crystal report.

### SUMMARY

The embodiments of the present disclosure describe systems, methods, and associated software for managing student transcripts. One of several embodiments of a transcript management system firstly includes a network interface configured in communication with a network that is associated with a university. The system further comprises a processing device configured to execute a transcript handling program, in which executing the transcript handling program includes collecting data corresponding to information of one or more students associated with the university. Particularly, this data is collected from various locations on the network via the network interface. The processing device is further configured to execute the transcript handling program by storing the data as multiple fields in multiple results tables. Thus, the transcript handling program allows an administrator of the university to customize how the multiple results tables are placed on a transcript.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components of the following figures are illustrated to emphasize the general principles of the present disclosure. Reference characters designating corresponding components are repeated as necessary throughout the figures for the sake of consistency and clarity.

FIG. 1 is a block diagram illustrating a transcript management system according to one embodiment.

FIG. 2 is a block diagram illustrating the transcript handling program shown in FIG. 1 according to one embodiment.

FIGS. 3-16 are diagrams of graphical user interfaces associated with the transcript handling program of FIG. 2 according to a number of embodiments.

FIGS. 17A-17E are diagrams illustrating a plurality of data fields associated with a plurality of results tables according to a number of embodiments.

### DETAILED DESCRIPTION

The embodiments of the present disclosure comprise transcript management systems that provide more flexibility than conventional transcript programs. Also, a user can more easily customize the transcripts to meet the needs of the university. For example, the transcript handling systems defined herein allow the users to define their own transcript report setup, view how the transcript will eventually look when printed, and customize a template used to enter data for use in the transcripts. Many of the fields that were hard-coded in conventional transcript programs can now be easily modified using the report template associated with the embodiments of the present disclosure.

Although a student's transcript may be about 100 lines or even longer, the conventional transcript programs create the transcript data in only one results field. The transcript normally contains a certain format that could not be easily reformatted according to the user's desires. Many of these changes can only be made by altering the COBOL code, which could be difficult and expensive.

In some respects, the text fields of the results table cannot be easily accessed, thereby making it difficult to customize the transcript. For example, it can be difficult for a user to customize a line of text regarding enrollment information or to change the format of the data. In order to control which fields will be printed, it may be necessary to modify the COBOL code. In another example, the format of labels may be hard-coded in the COBOL program, which can make modifications of labels difficult. Also, some simple tasks such as adding a page break, adding a column break, adding a blank line, changing a label, controlling white space, and other similar tasks can be time consuming and difficult to perform.

In conventional student transcript software, transcript requests are based on a batch request structure, where requests for multiple students are entered under one request. When such a batch request is made, many transcripts are accessed simultaneously, which can at times cause performance issues in the software. Sometimes these issues result in the inability to actually access the request.

In addition to the transcript formatting issues and the transcript requesting issues in the prior solutions, it can further be difficult to troubleshoot these issues and to customize the transcript program to the user's needs or desires. To customize certain aspects of the conventional transcript program, special knowledge of COBOL or the use of Crystal reports may be needed.

In place of a COBOL-based engine, the embodiments described herein are controlled by a new application engine process, which uses a hierarchical table structure allowing for greater control over how data is presented on the transcript. In some embodiments, the new application engine can use any suitable type of reporting application, such as, for example, XML Publisher from Oracle Corporation or other similar tool, to deliver the transcript. XML Publisher is built on open standards technology and supports multiple output formats. Another advantage of XML Publisher as a reporting tool is its use of templates to design the look of the document.

Using the embodiments herein, the user can more easily define the look of the transcript. Using one or more setup pages of the present embodiments, the user can select and sort the data. Also, the user can modify the template to create the university's unique look and to define how they would like the transcripts to appear. Rather than using conventional tools such as COBOL and Crystal Reports, the embodiments of the present disclosure can use application tools, such as PeopleTools application engine from Oracle Corporation, and XML Publisher or other similar reporting tools. As such, transcript designs can be easier to customize to the specific tastes of the university administrators. Furthermore, using the transcript management systems and methods described herein, there is less of a need for special programming knowledge, e.g., knowledge of COBOL, to operate and maintain the transcript management systems, processes, and programs.

In some embodiments, transcripts created using the transcript management systems described herein can be stored in a PDF format, which can be made available to a requestor. Therefore, administrators, students, and alumni can access the transcripts using a self-service route and receive the transcripts in the PDF format. Also, a control component of the transcript management systems can be used for processing batch transcripts from a single location. Thus, the user can make a transcript request, generate transcripts from that request, and print the transcripts from this single location.

Instead of creating a single results table as is done in conventional programs, the embodiments of the present disclosure can use a plurality of results tables. In some embodiments, dozens of results tables can be used, based on the different types of information included in the transcripts. With more results tables, the user has the ability to more easily make customizations or modifications as desired. For example, the transcript management systems can include a results table for an academic program, another for enrollment information, etc. In this respect, each field can be represented as a results table and can therefore be put in the transcript anywhere the user desires. Instead of placing all the gathered information into a single results table as is done in conventional programs, the embodiments of the present disclosure change how data is gathered from existing sources and placed into multiple results tables in memory.

Normally, when data was stored in only one table, each row in that table represented a row that could be seen on the printed report with all the formatting already in place. The user could not easily select or format certain pieces of data because that data was simply a line of data. However, with the processes described herein, this deficiency can be overcome and the user can essentially control any pieces of data as needed.

Using the embodiments of the present disclosure, the user can put the university's logo on the transcripts without external assistance. The user can use a sample template that pulls data in from various sources. From the template, the user can remove data that is not wanted in the transcripts. Also, the user can change how the data is spaced, change fonts, and perform other similar word processor type operations. Using the present transcript management systems, users can place university logos on the transcripts, use a sample template, remove data that is not wanted, change spacing and fonts, change appearance of transcripts, etc.

Since it is not necessary that all data is shown on the actual report, the transcript can be easier to customize. If the user wanted to add information that is not currently provided by the present transcript management systems, it may be desirable to add certain data into the data source or in the data template. With the added data, the user can then view the modified transcript to see how the changes will appear, thereby adding to the flexibility of the present systems and processes.

In some cases, there may be certain classes that a student takes that do not result in a final grade, but the class may still be required. Even though enrollment may be managed on a grading basis, a class that does not include a grade may still exist in the records of class enrollment. In this situation, the transcripts can be modified based on either the grading basis for only the classes that result in grades or enrollment information including all the classes attended regardless of whether a grade was received for the class or not. Therefore, the present transcript management systems may track both the grading basis information as well as enrollment information to offer different formats of how information is represented on the transcript. In addition, the transcript management systems may also include pass/fail grades that are recorded in one column of statistics and not in another. Therefore, data can be pulled from various sources and displayed in any one of a plurality of different set up formats.

The templates described herein can provide a uniform look that appears the same no matter how a user goes about viewing it. Therefore, the printed version of the transcript will be the same as it looks on-line. A requestor requesting access to a transcript can choice the type of transcript desired, request screen pages, make batch transcript requests, access self-service pages, etc. Furthermore, the requestor can inquire about transcripts, purge one or more of the requested transcripts, and other functions.

Although the systems, methods, processes, programs, software code, etc. described herein refer to the management of transcripts, it should be noted that the scope of the present disclosure also includes the management of other types of reports as well. With regard to management of other types of reports, it should further be noted that discussion herein of the term “university” with regard to transcripts may instead be related to a corporation or enterprise, wherein the report associated with the corporation or enterprise may not necessarily be a transcript but may instead be some other type of report.

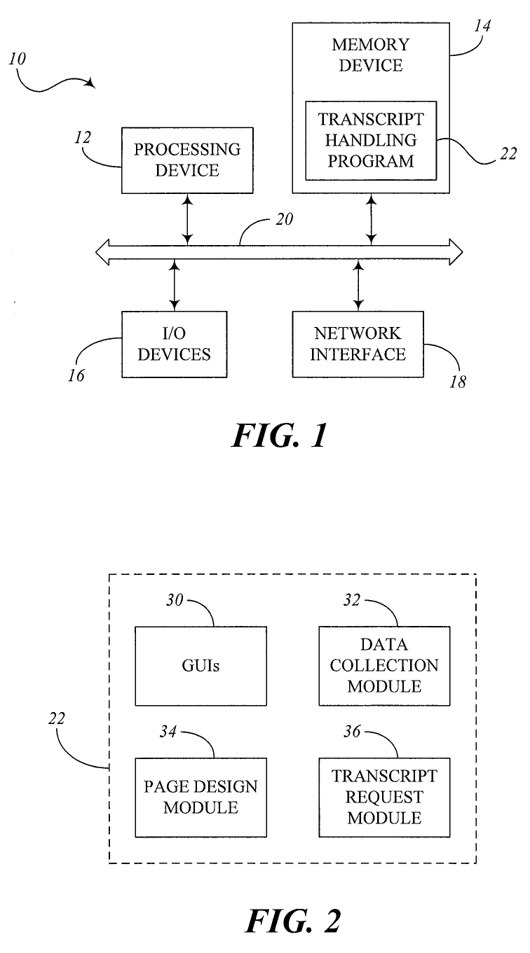

FIG. 1 is a block diagram of an embodiment of a transcript management system 10. In this embodiment, transcript management system 10 includes a processing device 12, memory device 14, input/output (I/O) devices 16, and network interface 18, each interconnected by a bus 20. For instance, transcript management system 10 may be one of any number of computers or computer systems connected within a network of a university. Such a network may include a enterprise resource planning (“ERP”) network in which various departments, e.g., admissions, enrollment, financial aide, etc., are accessible to transcript management system 10. Memory device 14, includes, among other things, a transcript handling program 22. In other embodiments transcript handling program 22 may be configured entirely or partially within memory device 14 and/or processing device 12.

Memory device 14 may include one or more internally fixed storage units, removable storage units, and/or remotely accessible storage units. The storage units can be configured to store information, data, instructions, and/or software code. The storage units may include any combination of volatile memory, such as random access memory (“RAM”), dynamic RAM (“DRAM”), etc., and/or non-volatile memory, such as read only memory (“ROM”), electrically erasable programmable ROM (“EEPROM”), flash memory, etc.

Transcript handling program 22 stored in memory device 14 can be executed by processing device 12. Various logical instructions or commands may be included in transcript handling program 22 for managing task requests within an organization. The embodiments of transcript handling program 22 described in the present disclosure can be implemented in hardware, software, firmware, or a combination thereof. When implemented in software or firmware, transcript handling program 22 is stored in memory device 14 and executed by processing device 12. Alternatively, when implemented in hardware, a transcript handling program can be implemented in processing device 12 using discrete logic circuitry, an application specific integrated circuit (“ASIC”), a programmable gate array (“PGA”), a field programmable gate array (“FPGA”), other suitable logic circuit, or any combination thereof.

Transcript handling program 22 or other software or logic code including executable logical instructions as described herein, can be embodied in computer-readable media for execution by any suitable processing device, such as processing device 12. The computer-readable media as described herein can include one or more suitable physical media components that can store the software, programs, or computer code for a measurable length of time.

I/O devices 16 may include input mechanisms such as keyboards, keypads, cursor control devices, or other data entry devices. The input mechanisms may be used for entering information in memory device 14. For example, to request a task, a user can type the request or enter the request using any suitable input mechanisms. I/O devices 16 also include output devices such as computer monitors, audio output devices, printers, or other peripheral devices.

Network interface 18 allows communication between transcript management system 10 and a network associated with the university, corporation, enterprise, etc. In this respect, data associated with a number of students can be gathered from various sources of the network and accumulated in memory device 14 in order to create a transcript for the students. Network interface 18 may be configured to access an ERP or other suitable type of network.

FIG. 2 is a block diagram of an embodiment of transcript handling program 22 shown in FIG. 1. In the embodiment of FIG. 2, transcript handling program 22 comprises one or more graphical user interfaces (GUIs) 30, a data collection module 32, a page design module 34, and a transcript request module 36.

Data collection module 32 is designed to gather or collect pertinent data and information about one or more students. Data collection module 32 accesses various data sources or databases on the network via network interface 18 (FIG. 1). The collected data can be stored in memory device 14 or other suitable storage devices. In some embodiments, transcript handling program 22 may be used in association with other tools for managing or handling university or enterprise operations. One example of such a tool is Campus Solutions created by Oracle Corporation. In this case, data collection module 32 can compile data from throughout the university management product. The following gathered information may appear on the transcript: student biographical data, enrollments, program and plan history, term statistics, degrees, milestones, transfer credit (courses, tests, etc.), financial aid awards, etc. The data can then be organized in different ways. For example, program history may be shown chronologically, organized in the transcript header, or shown within enrollment terms.

Page design module 34 includes logic allowing the user or university administrator to customize the physical appearance of the transcript by including various types of information or data at certain locations on the pages of the transcript. Page design module 34 allows customization of the look of the transcript. The various parts of the transcript can be formatted by positioning various fields or results tables wherever the user wishes. Some of the fields or results tables that can be positioned include a student's academic program, enrollments, transfer credits, etc. The student's academic program may include sub-plans, term statistics, transfer credit current GPA, combined current GPA, current GPA, etc. The cumulative statistics of enrollments may include enrollment cumulative GPA, enrollment grade points, enrollment units taken toward GPA, etc. The cumulative statistics of transfer credit may include transfer credit cumulative GPA, transfer credit grade points, transfer units taken toward GPA, etc.

Using page design module 34, the user can customize the location of various print areas, such as the location of enrollment details, an enrollment header, a transcript header, setup screen, student records, transcript print area table, etc. Also, row types can be modified using page design module 34. The row types can include at least the following data types and abbreviations of the data types: ADM—admissions, AST—academic standing, ATT—attendance dates, AWRD—scholarships and grants, BOM—basis of admission, DEG—local degrees, ENRH—enrollment history, ENRL—enrollment, EXD—external degrees, EXI—external institutions, INS—institution data, MLS—milestone, OTCR—other credits, PDT—print date, PERS—student information, PLN—plan, PRG—program, RCP—recipient, RHDR—transcript header, RQS—requester, RSN—reason, RTRL—transcript trailer, SGPA—special GPA, STAT—term statistics, THD—term header, THDH—term header—history, THON—term honors, TRCR—transfer credits, TSCR—test credits, TST—test scores, WTH—withdrawal, etc.

Transcript request module 36 includes logic to enable a person to request to access a transcript of a certain student or a batch of transcripts. The requester may be the user or university administrator who customizes the page design of the transcripts or can be any other person authorized to access one or more transcripts. For example, the requestor may be a student requesting to see his or her current transcript, an alumnus requesting to see his or her final transcript, or some other authorized person. When the one or more transcripts are accessed, the transcripts can be viewed on a suitable display device as desired or printed using a printer. The requestor can also request to have one or more transcripts transmitted to a third party, such as a prospective employee.

When access to one or more transcripts is requested, data collection module 32 retrieves updated data concerning the student or students from any number of various sources associated with the university. From the collected data, a template of the university's transcripts can be completed to customize the placement of the specific data on the transcripts.

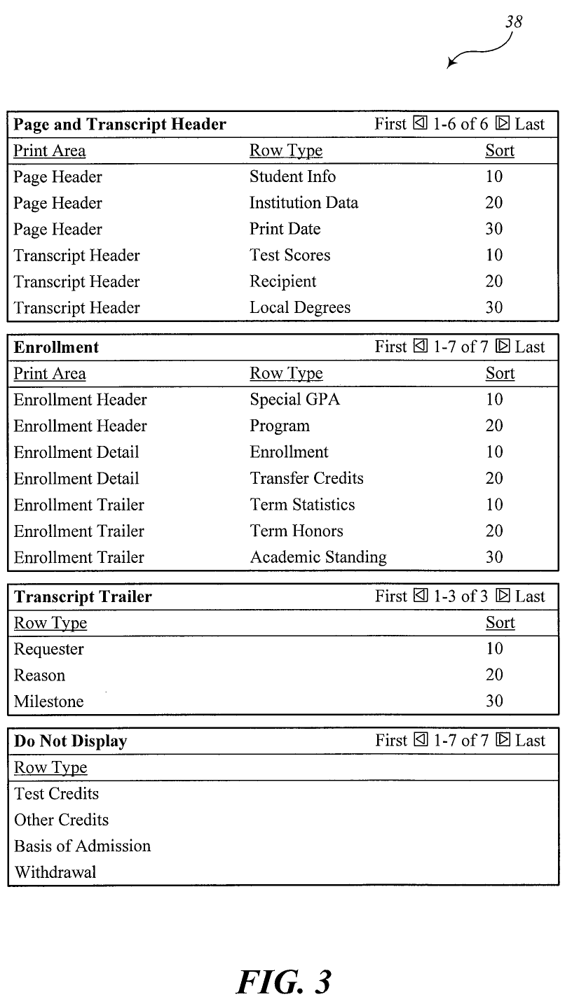

FIG. 3 is a screen view of an embodiment of a graphical user interface (GUI) 38. In this embodiment, GUI 38 is associated with page design module 34 shown in FIG. 2 and allows selection of various data to be positioned in a page header area, transcript header area, enrollment header area, transcript trailer area, and even data that is not displayed on the page. GUI 38 can also define the transcript type. In this example, the transcript type is shown in a sort view. The transcript type is a way to define the desired formatting of the transcript. It allows the user to choose which data to present on the transcript and how to sort the data.

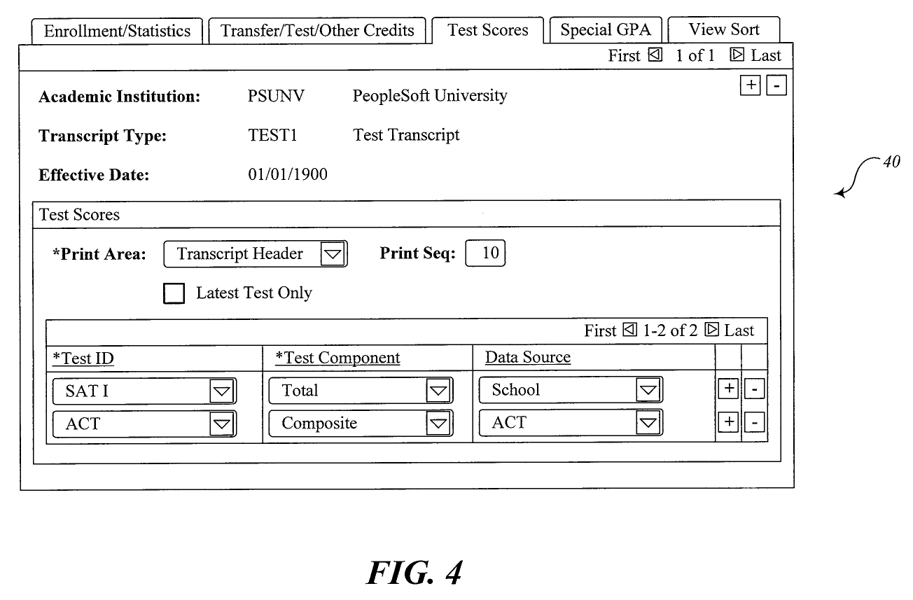

FIG. 4 is a screen view of an embodiment of a GUI 40. In this embodiment, GUI 40 is associated with page design module 34 shown in FIG. 2 and allows the user to define the transcript type. In this example, the transcript type is shown in a Test Scores view.

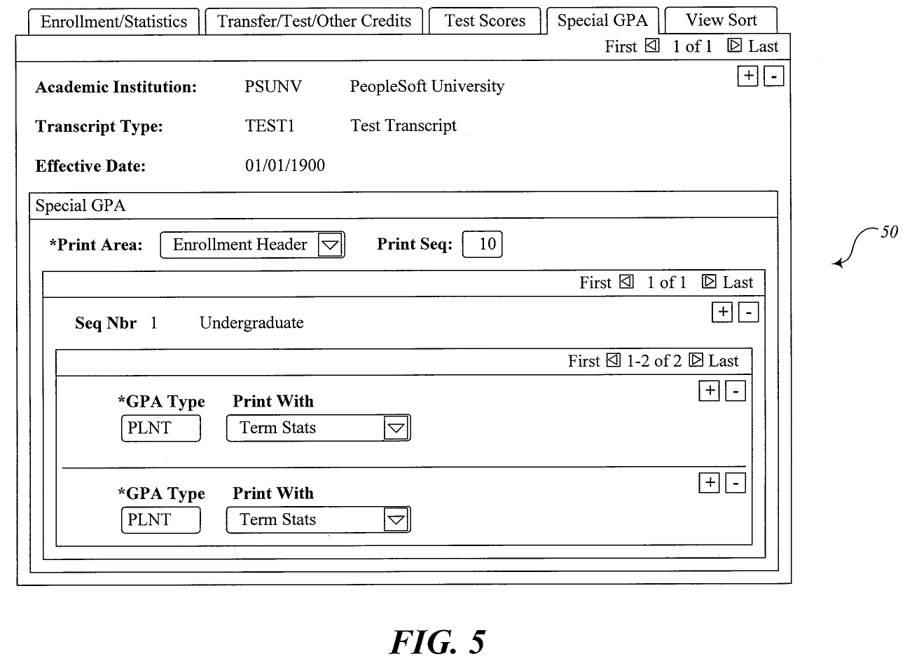

FIG. 5 is a screen view of an embodiment of a GUI 50. In this embodiment, GUI 50 is also associated with page design module 34 shown in FIG. 2 and allows the user to define the transcript type. In this example, the transcript type is shown in a Special GPA view.

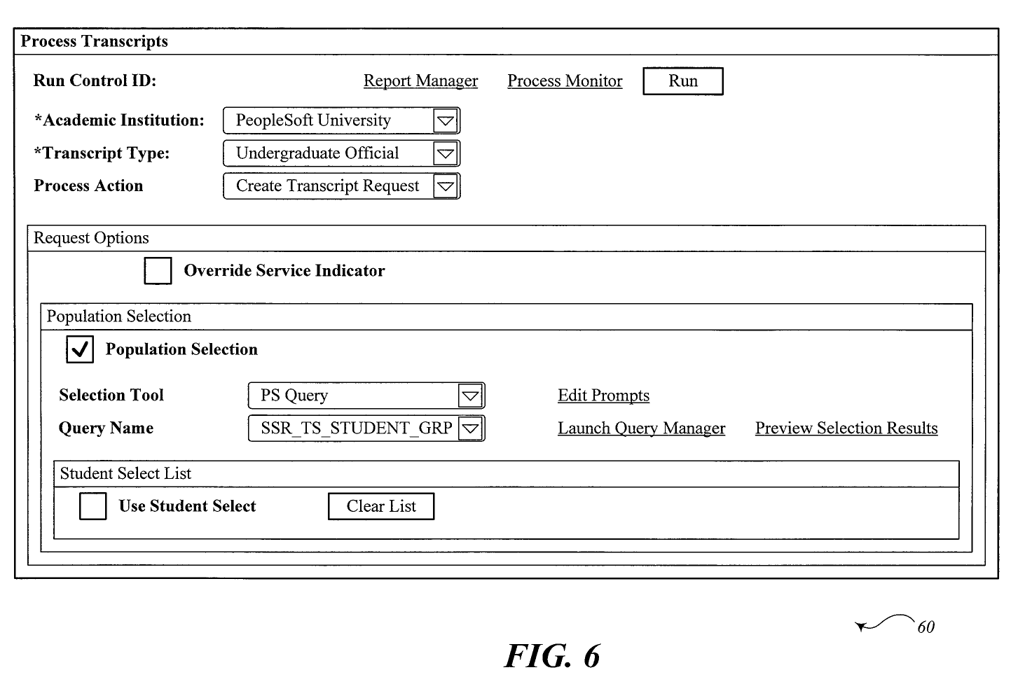

FIG. 6 is a screen view of an embodiment of a GUI 60. In this embodiment, GUI 60 is associated with transcript request module 36 shown in FIG. 2 and allows the user to process and print transcripts. Based on the user's process action, the available fields in GUI 60 change. The single page (GUI 60) can be used to request, generate, and print a transcript.

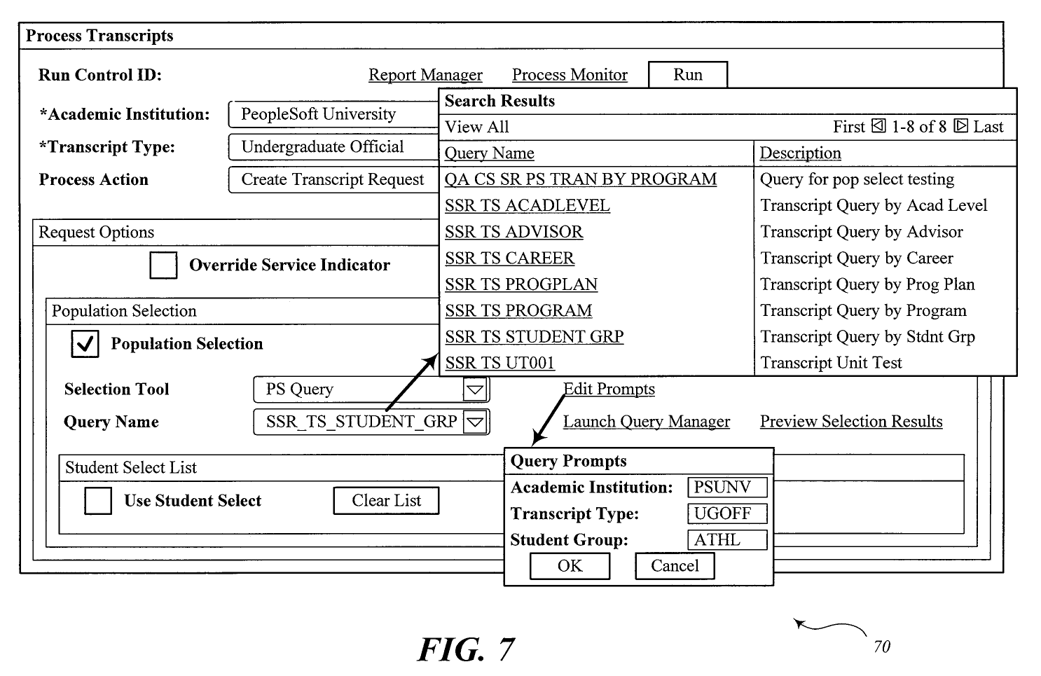

FIG. 7 is a screen view of an embodiment of a GUI 70. In this embodiment, GUI 70 is associated with transcript request module 36 shown in FIG. 2 and allows the user to process transcripts. In this example, GUI 70 shows a selection process within a Population Selection field. Additional information with respect to a Query Name and Query Prompts can be accessed using GUI 70.

Population Selection functionality provides the user with the ability to create populations based on the university's specific operating processes and to process batch transactions. Population Selection will allow the user to use PS Query, External File upload, or the Equation Engine to create specific groups of students for whom to order transcripts. In addition, the user can create a population or augment results by using a Student Select List section that allows inserting individual rows of students as necessary.

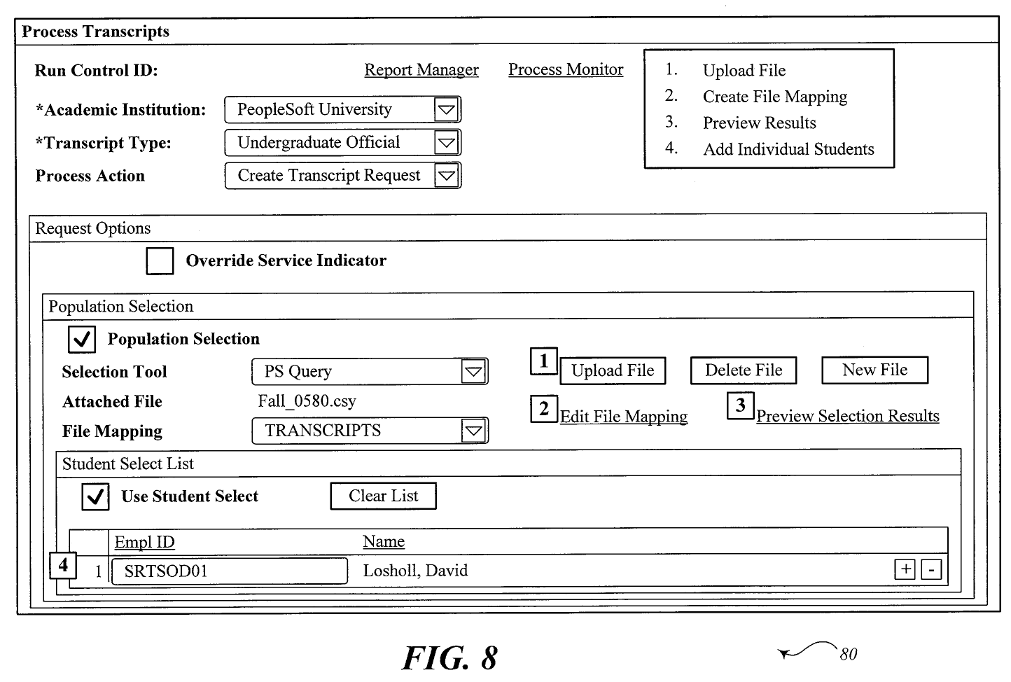

FIG. 8 is a screen view of an embodiment of a GUI 80. In this embodiment, GUI 80 is associated with transcript request module 36 shown in FIG. 2 and allows the user to upload a file, create file mappings, preview specific results, and add individual students. The Selection Tool in this example pulls files from an External File source.

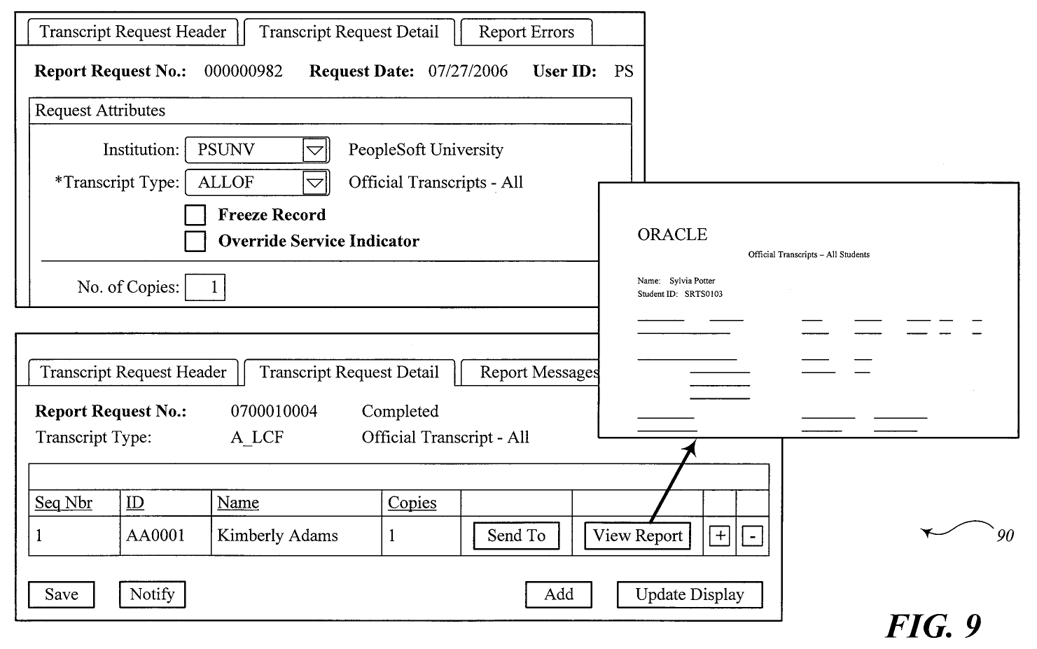

FIG. 9 is a screen view of an embodiment of a GUI 90. In this embodiment, GUI 90 is associated with page design module 34 shown in FIG. 2 and allows the user to view the details of a transcript. By selecting View Report, the user can view an official transcript of a particular student. The official transcript is the transcript that corresponds to how it appears in a final printed form.

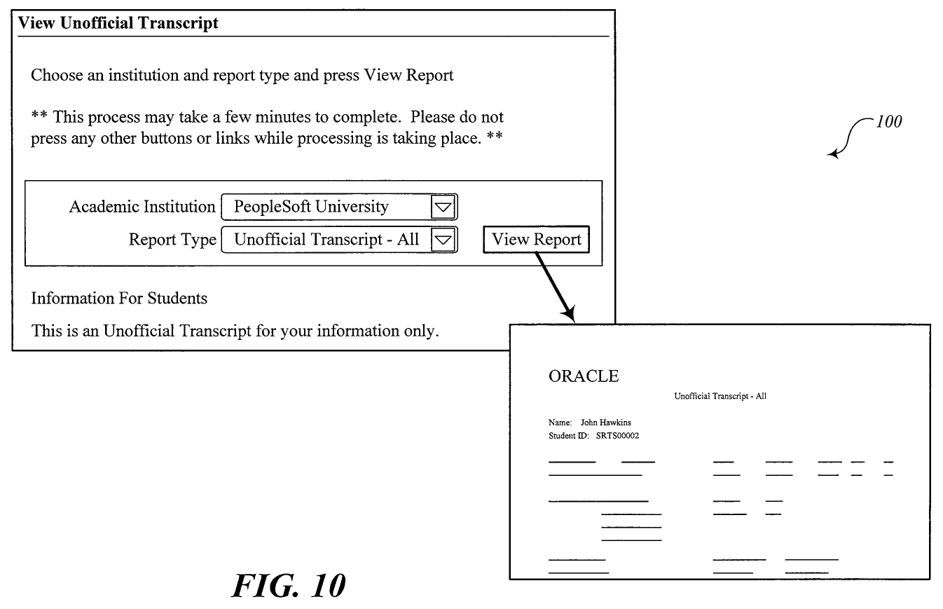

FIG. 10 is a screen view of an embodiment of a GUI 100. In this embodiment, GUI 100 is associated with transcript request module 36 shown in FIG. 2 and allows the user to view an unofficial transcript. This request may be associated with a self-service action when the requestor uses any remote computer, kiosk, or terminal to request access to the transcript.

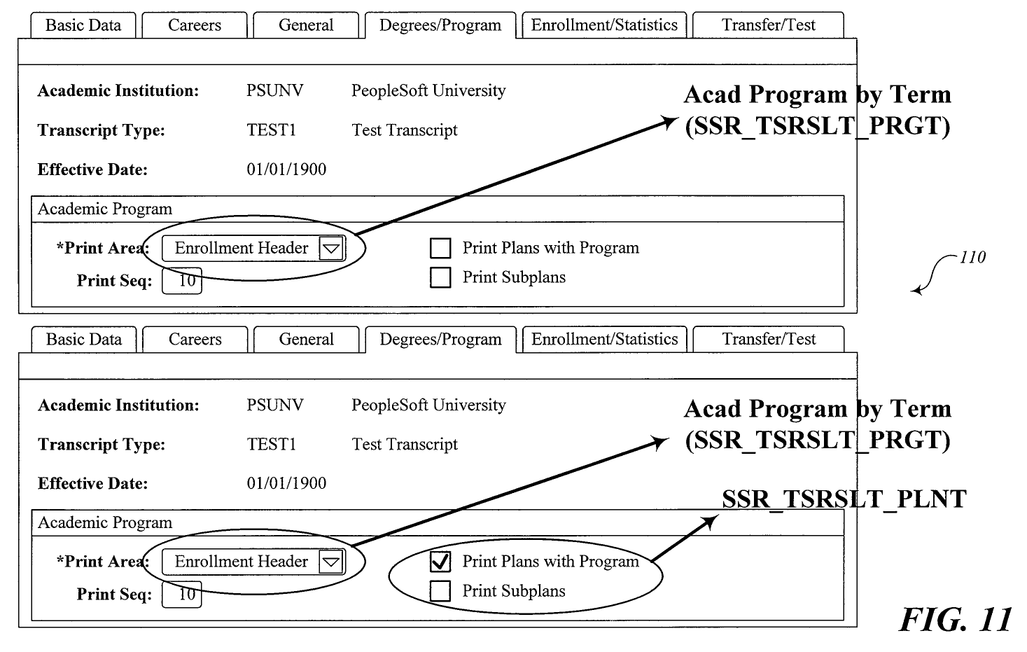

FIG. 11 is a screen view of an embodiment of a GUI 110. In this embodiment, GUI 110 is associated with page design module 34 shown in FIG. 2 and allows the user to enter degrees and academic program information.

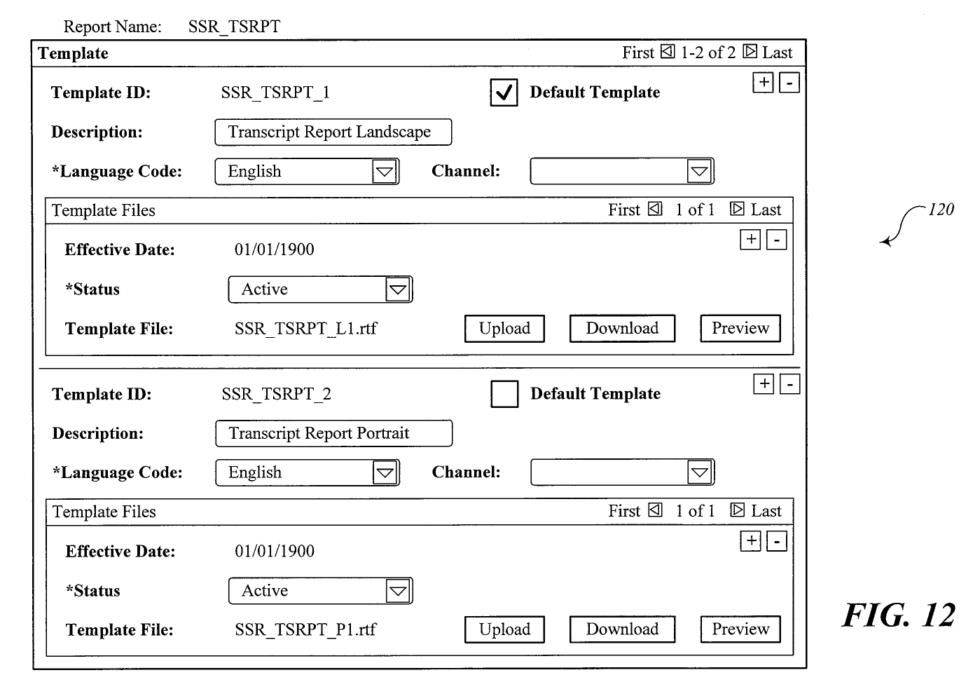

FIG. 12 is a screen view of an embodiment of a GUI 120. In this embodiment, GUI 120 is associated with page design module 34 shown in FIG. 2 and allows the user to define transcript appearance characteristics. In some embodiments, the layout of a transcript may be managed by a specific reporting or word processing program, such as XML Publisher. Two sample templates can be delivered for selection by the user. These samples can be retrieved from the reporting tool. In GUI 130, an example is shown in which the report name is SSR_TSRPT. For this report, the template ID is selected as SSR_TSRPT_{—}1, which corresponds to a landscape orientation. When the template ID of SSR_TSRPT_{—}2 is selected, the layout corresponds to a portrait orientation.

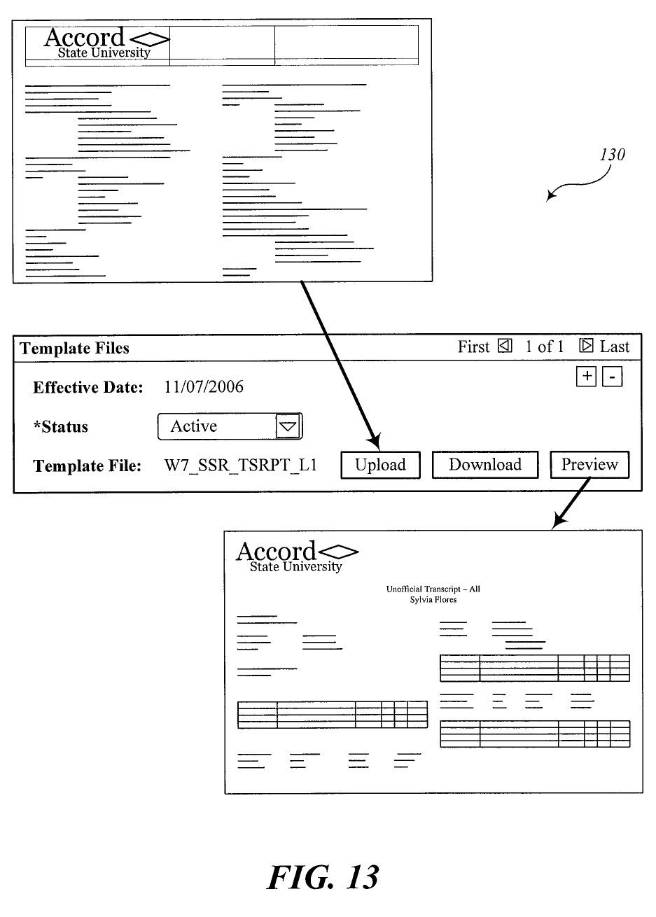

FIG. 13 is a screen view of an embodiment of a GUI 130. In this embodiment, GUI 130 is associated with page design module 34 shown in FIG. 2 and allows the user to upload template files and preview an unofficial version of the transcript. In coordination with a reporting tool, such as XML Publisher, templates can be delivered to the user for further modification. Also, the templates can be tested on a Report Definition field. Customized template files can be managed through the Report Definition. Templates can be previewed for testing and default templates can be set for use with transcript processing.

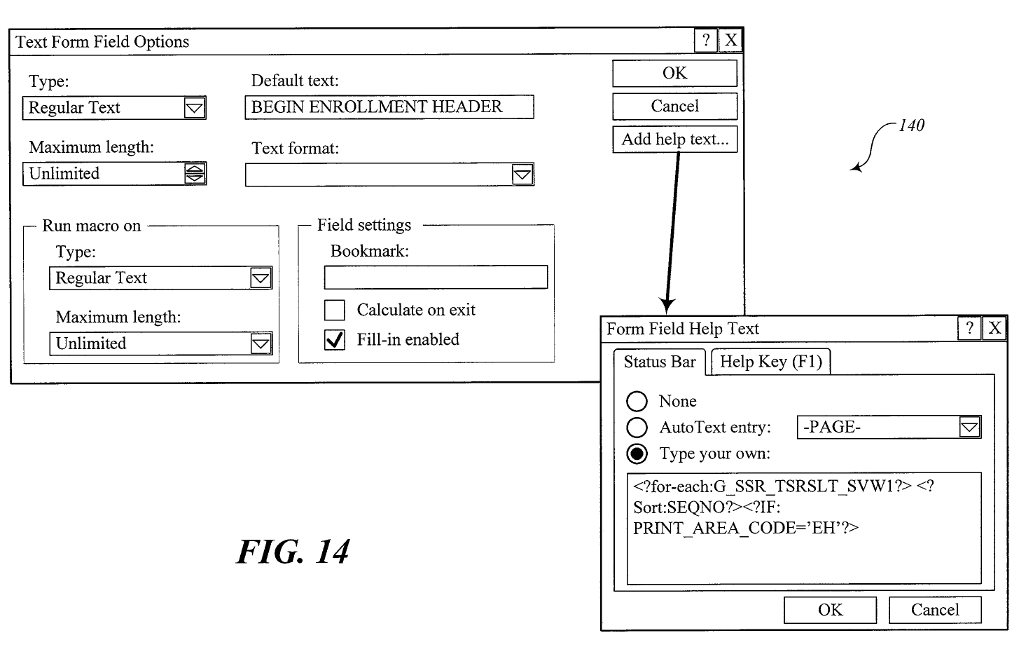

FIG. 14 is a screen view of an embodiment of a GUI 140. In this embodiment, GUI 140 is associated with page design module 34 shown in FIG. 2 and allows the user to modify or select text from field options. One default may include beginning a transcript with an enrollment header, i.e., Begin Enrollment Header.

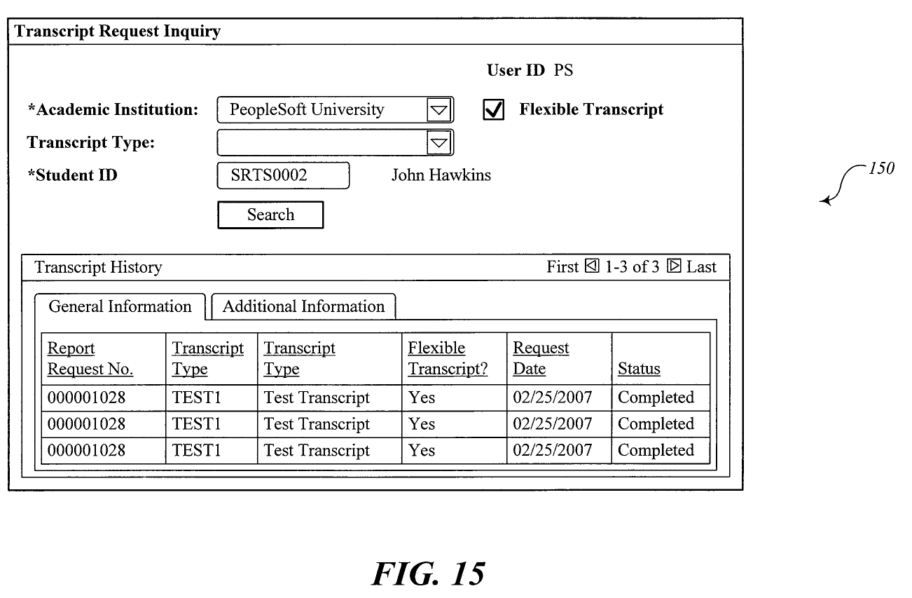

FIG. 15 is a screen view of an embodiment of a GUI 150. In this embodiment, GUI 150 is associated with transcript request module 36 shown in FIG. 2 and allows the user to inquire of requested transcripts. As students and alumni request transcripts to be forwarded to other institutions, internal departments, external employers, or other recipients, administrative users frequently need to access a single source of information about the transcript request status, pertinent dates, recipient information, request circumstances, etc. The Transcript Request Inquiry represents a quick and convenient way for staff to look up this information. In a readable grid format, the Transcript Request Inquiry allow the users to access the student's history of transcript requests, filter them by transcript type, sort results, and personalize the sequence of grid columns in order to provide better services.

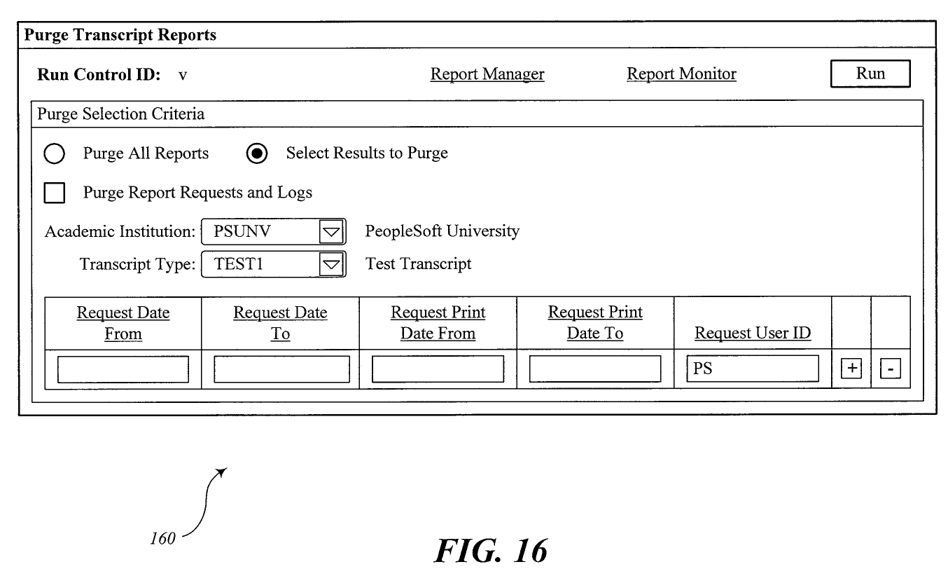

FIG. 16 is a screen view of an embodiment of a GUI 160. In this embodiment, GUI 160 is associated with transcript request module 36 shown in FIG. 2 and allows the user to purge transcript reports. When a number of transcripts are selected to view or modify information within the transcripts, the Transcript Purge process removes the transcripts from temporary storage. Information stored with respect to pertinent information of the students is not erased, but only the gathered information stored in cache is purged.

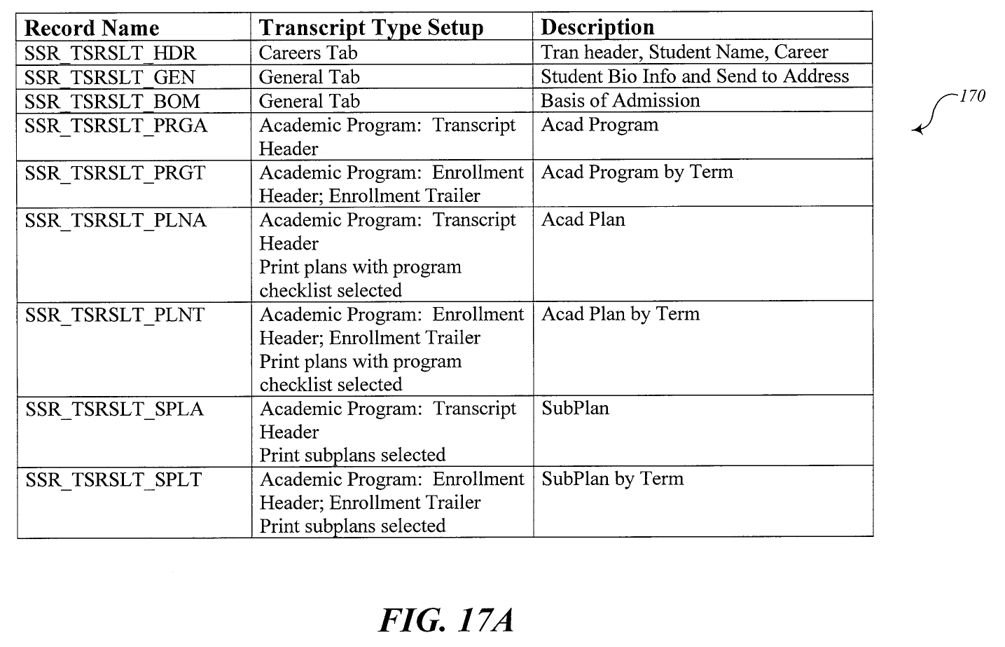

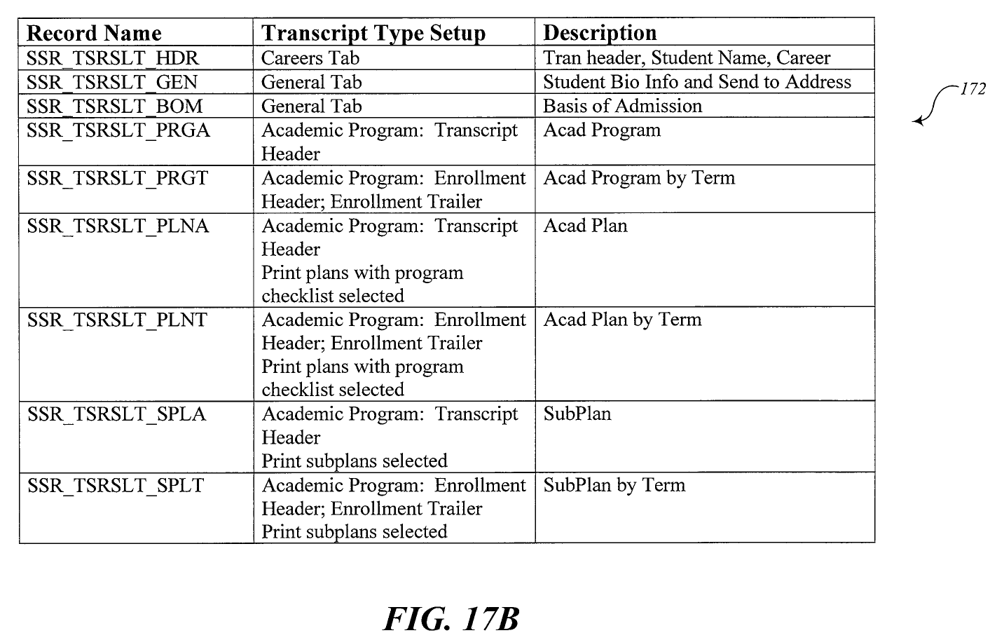

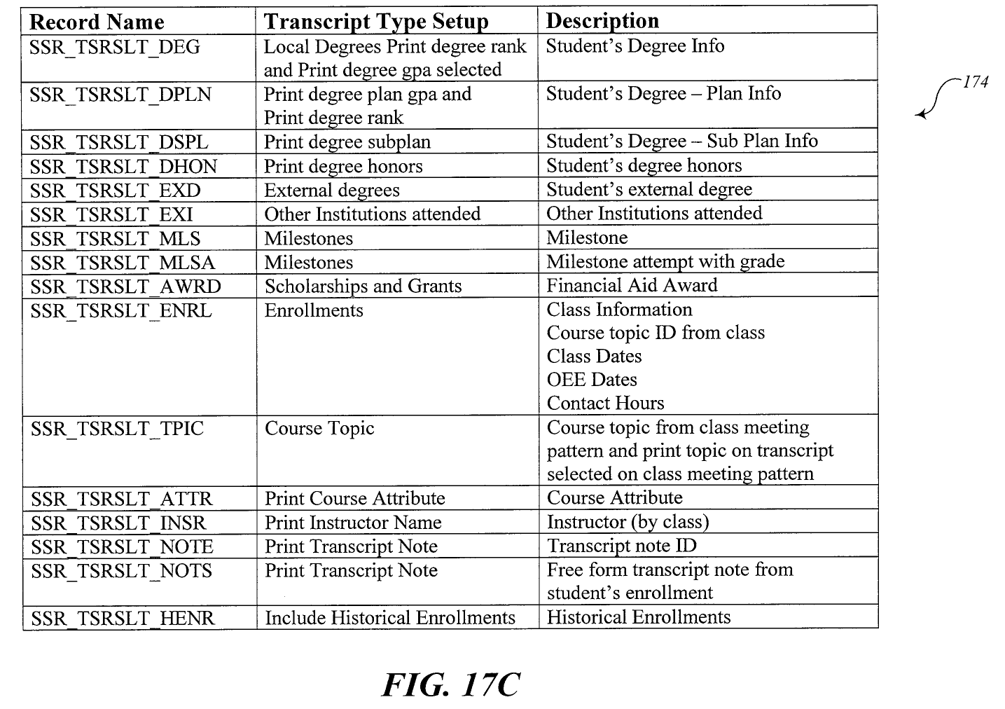

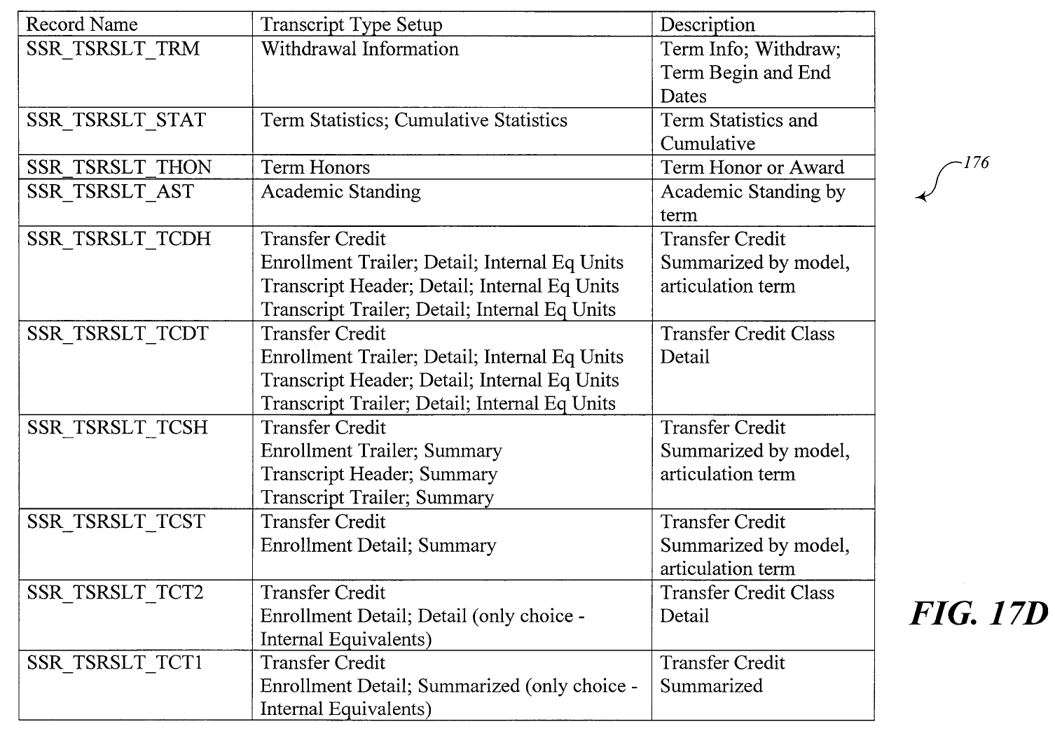

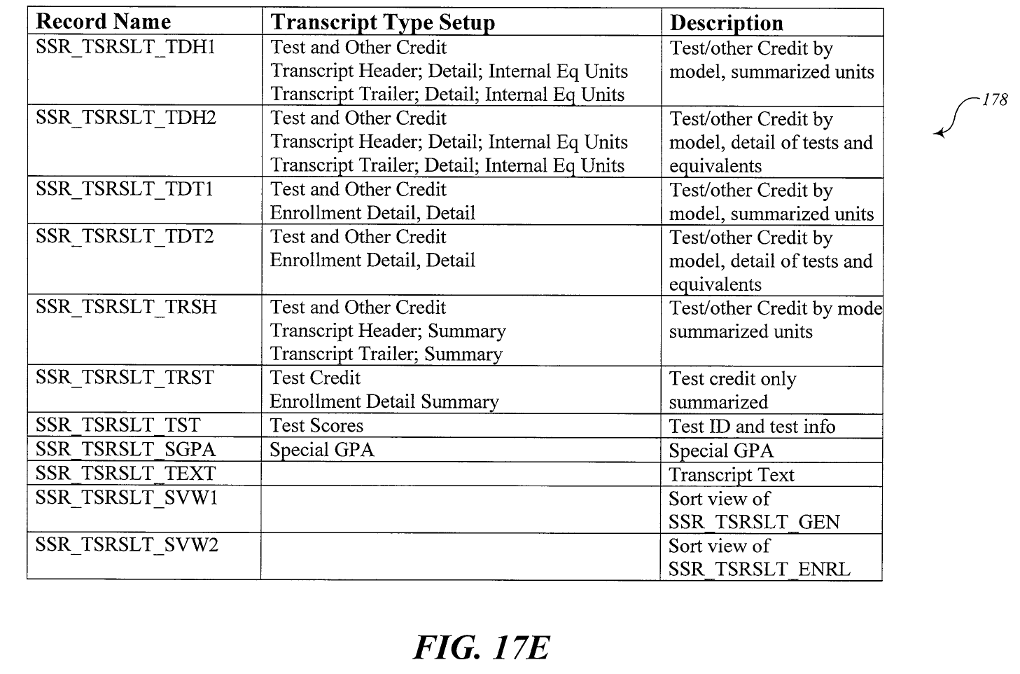

FIGS. 17A-17E are diagrams of embodiments of the results tables described with respect to transcript management system 10 (FIG. 1). FIG. 17A shows a number of data fields in results tables 170. FIG. 17B shows a number of data fields in results tables 172. FIG. 17C shows a number of data fields in results tables 174. FIG. 17D shows a number of data fields in results tables 176. And FIG. 17E shows a number of data fields in results tables 178. Each of the data fields of the results tables shown in FIG. 17 correlate to a section of the transcript type and are created based on the transcript type setup. There can be any number of data fields or results tables as desired. In some embodiments, there may be dozens of results tables, including at least those shown in FIG. 17. Only the results tables that correspond to the transcript type setup will be created.

Results tables include key fields for defining the transcripts. A report request number is assigned by the transcript process. A user can request a sequence number, which is a new sequence number based on an employee ID representing a person making a transcript access request. A report number corresponds to a sequence number to identify more than one career for the student. The sequence number represents a print sequence from transcript type information. The results tables can also include a field referred to as a print area code, which corresponds to the transcript header information, transcript trailer information, etc., extracted from the transcript type information. Also, a row type represents an academic program, student info, degrees, etc.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein represent a number of implementations or examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A transcript management system comprising:
a network interface configured in communication with a network associated with a university; and
a processing device configured to execute a transcript handling program, wherein executing the transcript handling program includes:
collecting data corresponding to information of one or more students associated with the university, the data collected from various locations on the network via the network interface;
storing the data as multiple fields in multiple results tables; and
allowing an administrator of the university to customize how the multiple results tables are placed on a transcript.

2. The transcript management system of claim 1, further comprising a memory device configured to store the transcript handling program and to allow the processing device to execute the transcript handling program.

3. The transcript management system of claim 1, wherein the transcript handling program is configured as hardware in the processing device.

4. The transcript management system of claim 1, further comprising input devices and output devices, the input devices configured to receive information from the administrator, the output device providing graphical information to the administrator.

5. The transcript management system of claim 4, wherein the input devices and output devices comprise at least one graphical user interface allowing the administrator to customize the appearance of the transcript.

6. A transcript handling program comprising:
logic adapted to present one or more graphical user interfaces to a user of the transcript handling program;
logic adapted to collect data from various sources throughout a network associated with a university, the data being organized into a plurality of results tables representing different fields of information;
logic adapted to enable the user to design a page layout of the transcript by placement of the results tables in different locations on the pages of the transcript.

7. The transcript handling program of claim 6, further comprising logic adapted to enable a requester to request access to the transcript.

8. The transcript handling program of claim 7, wherein the requestor makes the request to access the transcript from a remote location with respect to the network, and wherein the requestor is not the user who designs the page layout.

9. The transcript handling program of claim 7, wherein the logic adapted to enable the requestor to request access to the transcript is further adapted to allow the requestor to download a copy of the transcript in PDF format.

10. The transcript handling program of claim 7, wherein the logic adapted to present one or more graphical user interfaces is configured to enable the requestor to select student population information.

11. The transcript handling program of claim 7, wherein the logic adapted to enable the requestor to request access to the transcript is further adapted to enable the requestor to view an official view of the transcript or an unofficial view of the transcript.

12. The transcript handling program of claim 11, wherein the logic adapted to enable the requestor to request access to the transcript is associated with a single graphical user interface allowing the requestor to request, generate, and print a transcript from the single graphical user interface.

13. The transcript handling program of claim 6, wherein the logic adapted to present one or more graphical user interfaces is configured to enable the user to set up at least page header information, transcript header information, and enrollment header information.

14. The transcript handling program of claim 6, wherein the logic adapted to present one or more graphical user interfaces is configured to enable the user to enter test scores related to university entry tests.

15. The transcript handling program of claim 6, wherein the logic adapted to present one or more graphical user interfaces is configured to enable the user to select a transcript template.

16. A system for managing a student transcript, the system comprising:
means for collecting data associated with a student enrolled at a university, the data being collected from one or more data sources on a network associated with the university;
means for storing the collected data in a plurality of results tables, each results table corresponding to a data field that includes information to be placed on a transcript, the transcript comprising university-related information of the student; and
means for enabling a user to manipulate the results tables to be placed on the transcript.

17. The system of claim 16, wherein the means for enabling the user to manipulate the results tables enables the user to manipulate the information included in the results tables.

18. The system of claim 16, wherein the means for enabling the user to manipulate the results tables enables the user to place the results tables at specific locations on the transcript.

19. The system of claim 16, further comprising means for enabling a person to request access to the transcript.

20. The system of claim 19, wherein the person requesting access to the transcript is the student.

21. The system of claim 20, wherein the student requesting access to the transcript is an alumnus of the university.
